(19) United States
(12) Patent Application Publication
(10) Pub. No.: US 2010/0316918 A1
(43) Pub. Date: Dec. 16, 2010

(54) NANO-SCALE GAS SEPARATION DEVICE UTILIZING THIN FILM STRUCTURES FOR HYDROGEN PRODUCTION

(75) Inventors: Shriram Ramanathan, Acton, MA (US); Annamalai Karthikeyan, Quincy, MA (US)

Correspondence Address: CHOATE, HALL & STEWART/HARVARD UNIVERSITY, TWO INTERNATIONAL PLACE, BOSTON, MA, 02110, US

(73) Assignee: PRESIDENT AND FELLOWS OF HARVARD COLLEGE, Cambridge, MA (US)

(21) Appl. No.: 12/296,404

(22) PCT Filed: Apr. 9, 2007
(86) PCT No.: PCT/US07/66253

§ 371 Date: Apr. 16, 2010

Related U.S. Application Data
(60) Provisional application No. 60/790,440, filed on Apr. 7, 2006.
(60) Provisional application No. 60/796,745, filed on May 2, 2006.

(51) Int. Cl. H01M 8/06; H01B 1/08; B32B 18/00; C25C 7/04; C25B 9/08

(52) U.S. Cl. 429/422; 252/520.21; 252/520.4; 252/520.5; 252/521.1; 252/521.2; 252/518.1; 428/220; 204/295; 428/697; 204/252

(57) ABSTRACT

In various aspects, provided are substantially single phase ceramic membranes, gas separation devices based thereon, and methods of making the membranes. In various embodiments, the membranes and devices can be used for hydrogen production, such as in a fuel-cell.

### CROSS-REFERENCE TO RELATED APPLICATIONS

The present application claims the benefit of and priority to copending U.S. Provisional Patent Application Nos. 60/790,440, filed Apr. 7, 2006, and 60/796,745, filed May 2, 2006, the entire contents of both of which are herein incorporated by reference.

### BACKGROUND

Hydrogen is used in the manufacture of a wide variety of products including metals, edible fats and oils, and semiconductors and microelectronics. Hydrogen is also an important fuel source for energy conversion devices such as fuel-cell systems. Fuel cells also hold promise as low-particulate emission sources of power, as an alternative to gasoline powered vehicles, and as a means to provide more efficient use of energy.

The United States Department of Energy targets at least a 2% increase in energy efficiency per year to sustain economic growth and to control green house emission. Hydrogen is generally considered to be a clean and future energy source, which can be used as a fuel in a variety of applications. Hydrogen is traditionally prepared by steam membrane reformation and coal gasification. The hydrogen produced by such traditional methods, however, is often contaminated and not suited for transportation applications based on proton exchange membrane (PEM) fuel cells without costly purification.

### SUMMARY

In various aspects, provided are substantially single phase ceramic membranes, gas separation devices based thereon, and methods of making the membranes. In various embodiments, the membranes and devices can be used, e.g., for hydrogen production. In various embodiments, the devices separate oxygen from a mixture of gases and/or gaseous oxides (e.g., steam) and produce hydrogen.

In various embodiments, membranes of the present inventions are single phase mixed ionic and electronic conducting (MIEC) membranes comprising a double doped cerium oxide, zirconium oxide, and/or lanthanum gallium oxide. In various embodiments, the membranes comprise (a) a first dopant; (b) a second dopant; and (c) a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃. In various embodiments, provided are membranes with MIEC layers that are substantially a single phase. In various embodiments, provided are membranes with MIEC layers that are substantially free of grain boundaries.

In various embodiments, provided are membranes comprising substantially a single phase of a MIEC. In various embodiments, the membranes are one or more of: (a) less than about 1 μm thick; (b) less than about 800 nanometers (nm) thick; (c) less than about 600 nm thick; (d) less than about 400 nm thick; (e) less than about 200 nm thick; and (f) less than about 100 nm thick. As the thickness of various embodiments of the membranes of the present inventions can be less than 1 micrometer, the membranes of the present invention are sometimes referred to as nano-membranes for succinctness.

In various embodiments, provided are graded MIEC membranes, sometimes referred to by the abbreviation GMIC for succinctness. In various embodiments, a GMIC comprises two or more layers of nano-membrane MIEC layers, where the MIEC material of each layer is substantially a single phase of the MIEC material for that layer; each MIEC layer comprising (a) a first dopant; (b) a second dopant; and (c) a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃.

In various aspects, the present inventions provide a device for the production of hydrogen. In various embodiments, a device comprises (a) a membrane disposed within at least a portion of a housing, the membrane having a first surface and a second surface opposite the first surface; (b) a first chamber in fluid communication with a first fluid source, the first chamber being defined by the membrane and at least a portion of the housing; and (c) a second chamber in fluid communication with a second fluid source, the second chamber being defined by the membrane and at least a portion of the housing, the second chamber being in fluid communication with an outlet for the transfer of hydrogen gas. The membrane comprises at least one mixed ionic and electronic conductor layer comprising a first dopant; a second dopant; and a ceramic oxide; where the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃. In various embodiments, the membrane comprises a GMIC.

In various aspects, provided are methods of forming membranes of the present teachings. In various embodiments, the formation comprises the step of thin film deposition of a first dopant; a second dopant; and a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃.

It is to be understood that although materials of the present inventions are discussed as “membranes” that the actual form factor of a MIEC, GMIC, etc. is not limited to being planar or substantially planar. The single phase MIEC, GMIC, etc. compositions can have a wide variety of form factors including corrugated, curved, bent, cylindrical, etc. It is to be understood that single phase MIEC, GMIC layers can be formed on a wide variety of substrate materials and even in the pores of porous materials.

The foregoing and other aspects, embodiments, and features of the present inventions can be more fully understood from the following description and drawings. In the drawings like reference characters generally refer to like features and structural elements throughout the various figures. The drawings are not necessarily to scale, emphasis instead being placed upon illustrating general principles of various embodiments of the inventions.

### BRIEF DESCRIPTION OF THE DRAWINGS

FIG. 1 presents a schematic representation of a hydrogen separation process from steam using an oxygen ion conducting MIEC membrane.

FIGS. 2A and 2B depict, respectively, the thickness dependence of oxygen ion flux (J(O₂)=2J(H₂)) for \tilde{D} and Kₑₓ values, illustrating that the flux is substantially independent of bulk properties at nano-scales (less than about 1 μm).

FIG. 3 schematically depicts a graded mixed ionic and electronic conducting membrane (GMIC).

FIG. 4 schematically depicts a gas separation module for production of hydrogen.

### DETAILED DESCRIPTION OF VARIOUS EMBODIMENTS

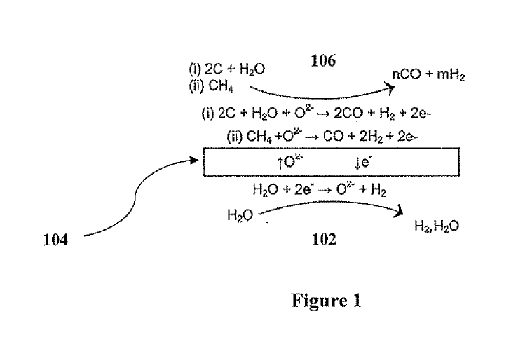

In various aspects, the present inventions provide MIEC comprising membranes. In various embodiments, MIEC membranes can be used for the production of hydrogen, for example, by a steam-methane reformation process, a steam-coal gasification process, etc. on one side of the membrane using oxygen extracted from steam on the other side of the membrane. FIG. 1 illustrates schematically representative reactions for the methane reformation (reaction series (i)) and coal gasification (reaction series (ii)) using oxygen extracted from steam on the first side 102 of the membrane 104 to drive the reactions on the other side 106 of the membrane; and illustrates that hydrogen is produced on both sides of the membrane in these processes.

The process is driven by the electrochemical Nernst potential, E, which can be represented by,

$$E = \frac{R T}{4 F} ln [ \frac{{p}_{O 2} ( 1 )}{{p}_{O 2} ( 2 )} ] \qquad ( 1 )$$

where the p_{O2's} represent the partial pressure of oxygen on either side of the membrane, R is the gas phase constant, T is temperature, and F the Faraday constant. The oxygen flux J(O₂) is a function of the bulk and surface rates of the membrane,

$$\begin{matrix}J ( {O}_{2} ) = \frac{\tilde{D}}{2 L} ( {C}_{v}^{b} - {C}_{v}^{a} ) ; & ( 2 a ) \\ J ( {O}_{2} ) = {K}_{ex}^{1} ( {C}_{v}^{b} - {C}_{v}^{1} ) ; and & ( 2 b ) \\ J ( {O}_{2} ) = {K}_{ex}^{2} ( {C}_{v}^{2} - {C}_{v}^{b} ) & ( 2 c )\end{matrix}$$

where J(O₂)=J(H₂), \tilde{D} (cm²/s) is the chemical diffusion coefficient of oxygen, and the Kₑₓ's (cm/s) are the surface exchange coefficient of oxygen at the gas-solid interface.

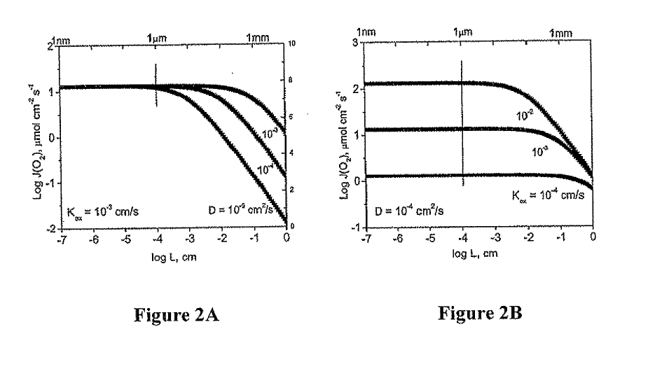

Referring to FIGS. 2A and 2B, the dependence on membrane thickness (L) the thickness dependence of oxygen ion flux (J(O₂)=2J(H₂)) for \tilde{D}, FIG. 2A, and Kₑₓ, FIG. 2B, is illustrated, and shows that flux is substantially independent of bulk properties at nano-scales (less than about 1 μm).

Traditional composite membranes can be difficult to fabricate and can achieve densifications of only about 95-97%. As a result, traditional composite membranes comprise two or more phases. The grain boundaries in these traditionally synthesized ceramic oxides can affect the bulk diffusion rates. The insulating phase(s) introduced in these traditional composites (e.g., the ionic phase is insulating to the electronic phase and vice-versa) can decrease the current density and thus electrochemical rates.

For example, traditional MIEC membranes possess oxygen chemical diffusion coefficient values, \tilde{D}, in the range of 10⁻⁶ to 10⁻⁴ cm²/s and oxygen surface exchange coefficient values, Kₑₓ, in the range of 10⁻⁵ to 10⁻³ cm/s. As a result, an average critical thickness (L value) of a traditional MIEC is around 100 μm to a few millimeters, which can limit the flux (e.g., of oxygen and hydrogen) to the bulk rates.

Thus with traditional membrane technology, the oxygen flux due to the bulk and two surfaces of the membrane are taken in series to produce an effective resistance, R_{eff}, given by:

$${R}_{eff} = ( \frac{1}{{K}_{ex}^{1}} + \frac{2 L}{\tilde{D}} + \frac{1}{{K}_{ex}^{2}} ) \qquad ( 3 )$$

In comparison, in various embodiments the present inventions provide membranes that are less than about 1 micrometer thick. When the thickness of the membrane is less than about a micrometer, the flux is substantially independent of bulk properties and can be determined by the surface exchange coefficient of oxygen and a high flux can be achieved, for example, with even a moderate (e.g., 10⁻⁵ cm²/s) bulk diffusion coefficient of oxygen \tilde{D}. In a sense, such membranes of the present inventions are virtually membraneless in that the flux of oxygen and hydrogen is substantially independent of bulk diffusion rate. For example, when L<1 micrometer <L_{critical}, the resistance can be expressed as,

$$R = ( \frac{1}{{K}_{ex}^{1}} + \frac{1}{{K}_{ex}^{2}} ) \qquad ( 4 )$$

### Membranes

In various embodiments membranes of the present inventions are single phase MIEC membranes comprising a double doped ceramic oxide. In various embodiments, the membranes comprise (a) a first dopant; (b) a second dopant; and (c) a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃.

In various embodiments, a membrane of the present inventions comprising (a) a first dopant; (b) a second dopant; and (c) a ceramic oxide, comprises a material system that can be represented by defect chemical reactions (5) and (6):

xA₂O₃+yB₂O₅+(1−x−y)MO₂→2xA′_{M}+2yB^{•}_{M}+1.5(x−y)O^{x}₀+(x−y)v^{••}₀ (5)

xA₂O₃+yB′O₂+(1−x−y)MO₂→2xA′_{M}+2yB′^{x}_{M}+1.5xO^{x}₀+xv^{••}₀ (6)

where the defect chemical reactions are written in Kröger-Vink notation, where M represents Ce and/or Zr; A represents Sm, Sc, Gd, and/or Y; B represents V, Nb, Ti, Mn, Cr, and/or Fe; v represents vacancies; ^{•} represents a positive charge relative to the site occupied; and ′ represents a negative charge relative to the site occupied, and ^{x} represents an overall neutral charge relative to the site occupied. In various embodiments, the B atoms are transition metal ions existing in multiple valence states, creating holes or electron defects depending on conditions (e.g., atmosphere in contact with membrane surface).

It is believed, without being held to theory that the double doping with a lower and high valence cations leads to the formation of ionic and electronic vacancies in the host materials. Further vacancies can be created by reduction, e.g., for process conditions. For example, additional oxygen vacancies and electrons at low oxygen partial pressure can be created,

O^{x}₀+2B^{x}_{M} [symbol] ½O₂(g)+O^{x}₀++2B^{x}_{M} (7)

where x>y results in the presence of both ionic and electronic vacancies for, e.g., bulk ambipolar transport and an increased surface exchange coefficient.

It is also believed, without being held to theory, that the nano-scale thickness of various preferred membranes increases space charge effects which enhance surface exchange rates at the surface of the membrane, resulting, e.g., in increased hydrogen production rates.

In various aspects, provided are graded MIEC membranes. In various embodiments, a GMIC comprises two or more layers of nano-membrane MIEC layers, each MIEC layer comprising two dopants a ceramic oxide; wherein one dopant comprises one of more of Y₂O₃, Sm₂O₃, Sc₂O₃, Gd₂O₃, SrO, MgO, and MnO; the other dopant comprises one or more metal oxides BₘOₙ, where B represents V, Nb, Ti, Mn, Cr or Fe; and the ceramic oxides are one or more of ZrO₂, CeO₂, and LaGaO₃.

In various preferred embodiments, membranes provided by the present inventions can have an oxygen and/or hydrogen flux rate that is not substantially controlled by the chemical diffusion coefficient \tilde{D}. The flux can be described by the surface exchange coefficient, Kₑₓ, see for example equation (4). In various embodiments, this realization is exploited to facilitate increasing flux rate. For example, improvements in the surface exchange rate can lead to and facilitate increasing flux. In one aspect, provided are structures comprising two or more single phase MIEC membranes of the present inventions chosen, for example, so that in combination the surface exchange rate of one or more of the surfaces are increased.

In various embodiments the surface is graded by grading the dopant levels between MIEC layers of the GMIC. The dopant levels of different surfaces of the GMIC can be selected to improve the surface exchange rate under the process conditions (e.g., chemical composition, pressure, temperature, etc.) that surface is exposed to. For example, the dopant levels of a surface of a first layer exposed to a first set of process conditions can be selected to facilitate surface exchange under the first set of conditions while the surface of a second layer, exposed to a second set of process conditions has dopant levels selected to facilitate surface exchange under the second set of conditions.

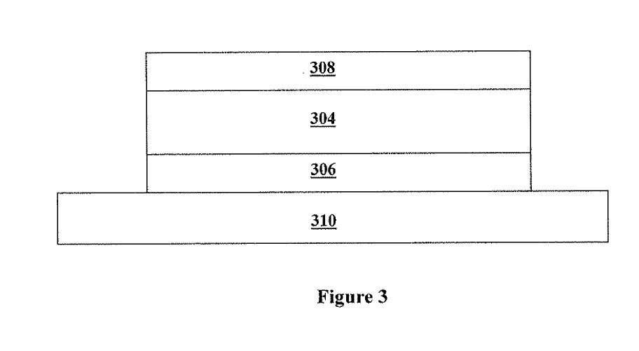

Referring to FIG. 3, a schematic illustration of various embodiments of a GMIC is shown. In various embodiments, a GMIC comprises two or more MIEC layers (304, 306, 308). In various embodiments, a GMIC comprises (a) a first MIEC layer 304 having a thickness less than about 2000 nm, preferably in the range between about 200 nm and about 2000 nm, and more preferably less than about 1000 nm; (b) second MIEC layer 306 having a thickness less than about 200 nm, preferably in the range between about 20 nm and about 200 nm; and (c) a third MIEC layer 308 having a thickness less than about 200 nm, preferably in the range between about 20 nm and about 200 nm; wherein each of the first second and third layers comprise a single phase double doped ceramic oxide having a substantially 100% density of the single phase.

In various embodiments, the first MIEC layer comprises (a) a first dopant; (b) a second dopant; and (c) a first ceramic oxide; the first MIEC layer comprises (a) a third dopant; (b) a fourth dopant; and (c) a second ceramic oxide; and the third the first MIEC layer comprises (a) a fifth dopant; (b) a sixth dopant; and (c) a third ceramic oxide; wherein the first, third and fifth dopants are each independently one or more of Y₂O₃, Sm₂O₃, Sc₂O₃, Gd₂O₃, SrO, MgO, and MnO; the second, fourth and sixth dopants are each independently one or more metal oxides BₘOₙ, where B represents V, Nb, Ti, Mn, Cr or Fe; and the first, second and third ceramic oxides are each independently one or more of ZrO₂, CeO₂, and LaGaO₃.

Referring again to FIG. 3, in various embodiments a GMIC can be supported by and/or deposited on one or more substrates 310. A wide variety of substrates can be used that permit the passage of oxygen and/or hydrogen to and/or from the membrane, such as, e.g., a porous refractory ceramic materials. For example, in various embodiments, the membrane is deposited on a porous alumina, porous silicon, etc.

### Devices

In various aspects, provided are gas separator device for separating hydrogen from water vapor. The gas phase separators of the present inventions comprise: (a) a housing; (b) a membrane disposed within at least a portion of the housing, the membrane having a first surface and a second surface, the first surface being opposed to the second surface, and the membrane comprising, substantially single phase of a solid material comprising a first dopant; a second dopant; and a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃; (e) a first chamber defined by the housing and the first surface; and (d) a second chamber defined being on the opposite side of the membrane from the first camber; wherein the device is configured to produce hydrogen gas from water vapor in at least one of the first and second chambers.

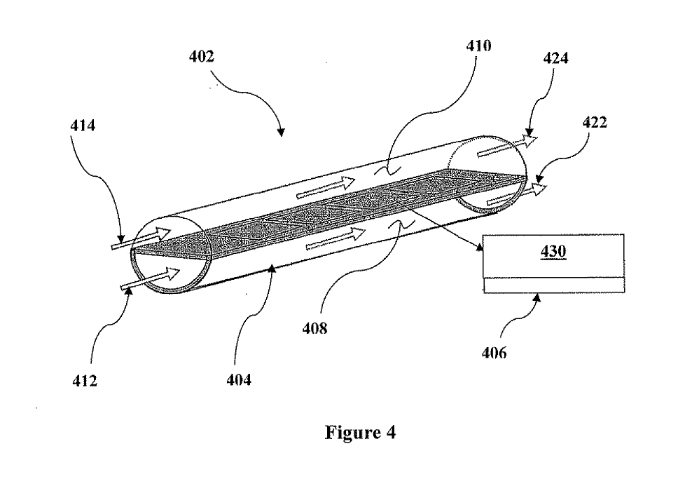

In various applications, the gas separator device comprises several modules, e.g., membrane chips disposed on a substrate with the substrate embedded and sealed to a housing (e.g., a ceramic tube). A schematic illustration of an example of a gas phase separator device is provided in FIG. 4.

Referring to FIG. 4, in various embodiments, a gas separator 402 for separating hydrogen from water vapor comprises a housing 404 and a membrane portion 406 disposed within at least a portion of the housing, the first surface of the membrane and the housing 404 defining a first chamber 408 and a second chamber 410 opposite the first chamber. In operation, for example, a fluid (e.g., liquid and/or gas) is fed into the first 412 and second 414 chambers. One of the feeds (412, 414) comprises steam. In various embodiments, the other feed comprises methane, gasified coal (e.g., carbon and water) or some other suitable fuel. The device is configured to produce hydrogen gas in one or both of the product streams (422, 424) of the device.

In various embodiments, the membrane comprises a GMIC comprising two or more layers of a substantially single phase of a solid material comprising a first dopant; a second dopant; and a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃.

Referring again to FIG. 4, in various embodiments the multiple membrane portions (406) are supported by and/or deposited on a substrate 430. A wide variety of substrates can be used that permit the passage of oxygen and/or hydrogen to and/or from the membrane, such as, e.g., a porous refractory ceramic materials. For example, in various embodiments, the membrane is deposited on a porous alumina, porous titania, porous silicon, etc.

In various embodiments, the membrane comprising a single phase of a MIEC comprises a MIEC having a substantially 100% density of a single phase. In various embodiments, the membrane is one or more of: (a) less than about 1 μm thick; (b) less than about 800 nm thick; (c) less than about 600 nm thick; (d) less than about 400 nm thick; (e) less than about 200 nm thick; and (f) less than about 100 nm thick.

In various embodiments, the hydrogen production rate of the gas separator device is substantially independent of the of the oxygen chemical diffusion coefficient of the membrane. In various embodiments, the current density through the membrane of the device is substantially independent of the of the oxygen chemical diffusion coefficient of the membrane.

### Methods

In various aspects, provided are methods of forming membranes of the present teachings. In various embodiments, the formation comprises the step of thin film deposition of a first dopant; a second dopant; and a ceramic oxide; wherein the first dopant is one of more of Y₂O₃, Sm₂O₃, Sc₂O₃, Gd₂O₃, SrO, MgO, and MnO; the second dopant is one or more metal oxides BₘOₙ, where B represents V, Nb, Ti, Mn, Cr or Fe; and the ceramic oxide is one or more of ZrO₂, CeO₂, and LaGaO₃. Preferably, the proportions of the dopants and ceramic oxides are in accord with those obtainable form equations (5) and (6).

The membranes of the present inventions do not require sintering to provide the single phase structures or other properties of the membrane. In various embodiments, the methods of the present invention form a membrane wherein the formation process occurs below about 800° C.

In various embodiments, the step of thin film deposition comprises one or more of a chemical vapor deposition (PECVD), plasma enhanced chemical vapor deposition (PVD), electrochemical vapor deposition (EVD), electron beam evaporation, sputtering (e.g., by thermal evaporator, plasma, laser, RF sputtering, reactive sputtering, etc.), and molecular beam epitaxy (MBE). For example, in various embodiments, the step of thin film deposition comprises co-sputtering of two or more of the first dopant, the second dopant and the ceramic oxide onto a substrate. In various embodiments, the step of thin film deposition comprises co-evaporation of two or more of the first dopant, the second dopant and the ceramic oxide.

In various embodiments, a GMIC can be fabricated by forming a first single phase MIEC membrane by thin film deposition of a first dopant; a second dopant; and a ceramic oxide on a substrate, followed by formation of a second single phase MIEC membrane by thin film deposition of a third dopant; a fourth dopant; and a ceramic oxide on the first single phase MIEC membrane. The process can be repeated for additional single phase MIEC layers. The dopants between layers can, for example, comprise one or more different chemical species. The dopants between layers can, for example, comprise one or more of the chemical species, where at least one of the dopants has a different concentration in the layer than that found in an immediately adjacent layer. Preferably, the proportions of the dopants and ceramic oxides are in accord with those obtainable form equations (5) and (6).

A wide variety of substrates can be used to form a single phase MIEC and/or GMIC. Preferably, the substrate is porous to oxygen and hydrogen. Examples of suitable substrate materials include, but are not limited to, porous alumina, porous titania, and porous silicon.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated provisional applications to which the present application claims priority to and the benefit of, literature and similar materials differs from or contradicts this application, including but not limited to defined terms, term usage, described techniques, or the like, this application controls.

The section headings used herein are for organizational purposes only and are not to be construed as limiting the subject matter described in any way.

While the present inventions have been described in conjunction with various embodiments and examples, it is not intended that the present inventions be limited to such embodiments or examples. On the contrary, the present inventions encompass various alternatives, modifications, and equivalents, as will be appreciated by those of skill in the art.

While the present inventions have been particularly shown and described with reference to specific illustrative embodiments, it should be understood that various changes in form and detail may be made without departing from the spirit and scope of the present inventions. Therefore, all embodiments that come within the scope and spirit of the present inventions, and equivalents thereto, are claimed. The claims, descriptions and diagrams of the methods, systems, and assays of the present inventions should not be read as limited to the described order of elements unless stated to that effect.

1. A substantially single phase mixed ionic and electronic conducting film comprising, a mixed ionic and electronic conductor material, the conductor material comprising:
a first dopant comprising one or more of Y₂O₃, Sm₂O₃, Sc₂O₃, Gd₂O₃, SrO, MgO, and MnO;
a second dopant comprising one or more metal oxides of the general formula BₘOₙ, where B represents V, Nb, Ti, Mn, Cr or Fe, where m and n are chosen based on the valence of the metal; and
a ceramic oxide comprising one or of ZrO₂, CeO₂, and LaGaO₃; wherein
the conductor material is substantially a single phase of the conductor material.

2. A membrane formed from the conducting film of claim 1, wherein the membrane comprises a layer of the conductor material that is less than about 2000 nm thick.

3. The membrane of claim 2, wherein the conductor material is less than about 800 nm thick.

4. The membrane of claim 3, wherein the conductor material is less than about 300 nm thick.

5. A membrane formed from the conducting film of claim 1, wherein thickness of the membrane is less than about 2000 nm and the flux rate of oxygen through the membrane is substantially independent of the diffusion coefficient for oxygen for the membrane.

6. A membrane formed from the conductor of claim 1, wherein thickness of the membrane is less than about 2000 nm and the flux rate of hydrogen through the membrane is substantially independent of the diffusion coefficient for hydrogen for the membrane.

7. The mixed ionic and electronic conductor of claim 1, wherein the conductor material is substantially free of grain boundaries.

8. A mixed ionic and electronic conductor structure comprising, two or more layers of mixed ionic and electronic conductor material, the material of each layer comprising two dopants and a ceramic oxide, wherein
one dopant of each layer comprises Y₂O₃, Sm₂O₃, Sc₂O₃, Gd₂O₃, SrO, MgO, or MnO, the other dopant of each layer comprises a metal oxide of the general formula BₘOₙ, where B represents V, Nb, Ti, Mn, Cr or Fe, where m and n are chosen based on the valence of the metal, and the ceramic oxide of each layer comprises ZrO₂, CeO₂, or LaGaO; and
wherein the conductor material of each layer is substantially a single phase of the conductor material for that layer.

9. The mixed ionic and electronic conductor structure of claim 8, comprising:
a first mixed ionic and electronic conductor material layer disposed on a second mixed ionic and electronic conductor material layer;
the first layer comprising:
a first dopant;
a second dopant; and
a first ceramic oxide;
and the second layer comprising:
a third dopant;
a fourth dopant; and
a second ceramic oxide.

10. The mixed ionic and electronic conductor structure of claim 9, wherein the first dopant and the third dopant are substantially the same but present in different concentrations in the first and second layers.

11. The mixed ionic and electronic conductor structure of claim 9, wherein the second dopant and the fourth dopant are substantially the same but present in different concentrations in the first and second layers.

12. The mixed ionic and electronic conductor structure of claim 9, wherein the first ceramic oxide and the second ceramic oxide are substantially the same.

13. The mixed ionic and electronic conductor structure of claim 8, wherein each mixed ionic and electronic conductor material layer is less than about 2000 nm thick.

14. The mixed ionic and electronic conductor structure of claim 8, wherein each mixed ionic and electronic conductor material layer is less than about 1000 nm thick.

15. The mixed ionic and electronic conductor structure of claim 8, wherein each mixed ionic and electronic conductor material layer is less than about 800 nm thick.

16. A membrane formed from the mixed ionic and electronic conductor structure of claim 8, wherein the flux rate of oxygen through the membrane is substantially independent of the diffusion coefficient for oxygen for the mixed ionic and electronic conductor layers of the mixed ionic and electronic conductor structure.

17. A membrane formed from the mixed ionic and electronic conductor structure of claim 8, wherein the flux rate of hydrogen through the membrane is substantially independent of the diffusion coefficient for hydrogen for the mixed ionic and electronic conductor layers of the mixed ionic and electronic conductor structure.

18. The mixed ionic and electronic conductor structure of claim 8, wherein the mixed ionic and electronic conductor layers are substantially free of grain boundaries.

19. A hydrogen production device, comprising:
a membrane disposed within at least a portion of a housing, the membrane having a first surface and a second surface opposite the first surface;
a first chamber in fluid communication with a first fluid source, the first chamber being defined by the membrane and at least a portion of the housing; and
a second chamber in fluid communication with a second fluid source, the second chamber being defined by the membrane and at least a portion of the housing, the second chamber being in fluid communication with an outlet for the transfer of hydrogen gas; wherein
the membrane comprises a mixed ionic and electronic conductor of claim 1.

20. The hydrogen production device of claim 19, wherein the membrane comprises a porous substrate and at least a portion of the mixed ionic and electronic conductor is disposed on the porous substrate.

21. A hydrogen production device, comprising:
a membrane disposed within at least a portion of a housing, the membrane having a first surface and a second surface opposite the first surface;
a first chamber in fluid communication with a first fluid source, the first chamber being defined by the membrane and at least a portion of the housing; and
a second chamber in fluid communication with a second fluid source, the second chamber being defined by the membrane and at least a portion of the housing, the second chamber being in fluid communication with an outlet for the transfer of hydrogen gas; wherein
the first membrane surface comprises the surface of a first mixed ionic and electronic conductor layer of claim 1, and the second membrane surface comprises the surface of a second mixed ionic and electronic conductor layer of claim 1.

22. The hydrogen production device of claim 19, wherein the rate of hydrogen production is substantially independent of the diffusion coefficient for hydrogen for the mixed ionic and electronic conductor portion of the membrane.

23. The hydrogen production device of claim 19, wherein the current density through the membrane of the device is substantially independent of the of the oxygen chemical diffusion coefficient of the mixed ionic and electronic conductor portion of the membrane.

24. The hydrogen production device of claim 19, wherein the first liquid source is a source of methane gas.

25. The hydrogen production device of claim 19, wherein the first liquid source is a source of gasified coal.

26. The hydrogen production device of claim 19, wherein the second liquid source is a source of water vapor.

27. The hydrogen production device of claim 19, wherein the device is configured as a fuel-cell for the production of electricity.

28. The mixed ionic and electronic conductor structure of claim 9, wherein the mixed ionic and electronic conductor layers are substantially free of grain boundaries.

29. A hydrogen production device, comprising:
a membrane disposed within at least a portion of a housing, the membrane having a first surface and a second surface opposite the first surface;
a first chamber in fluid communication with a first fluid source, the first chamber being defined by the membrane and at least a portion of the housing; and
a second chamber in fluid communication with a second fluid source, the second chamber being defined by the membrane and at least a portion of the housing, the second chamber being in fluid communication with an outlet for the transfer of hydrogen gas; wherein
the membrane comprises a mixed ionic and electronic conductor of claim 8.

30. The hydrogen production device of claim 29, wherein the rate of hydrogen production is substantially independent of the diffusion coefficient for hydrogen for the mixed ionic and electronic conductor portion of the membrane.

31. The hydrogen production device of claim 29, wherein the current density through the membrane of the device is substantially independent of the of the oxygen chemical diffusion coefficient of the mixed ionic and electronic conductor portion of the membrane.

32. The hydrogen production device of claim 29, wherein the first liquid source is a source of methane gas.

33. The hydrogen production device of claim 29, wherein the first liquid source is a source of gasified coal.

34. The hydrogen production device of claim 29, wherein the second liquid source is a source of water vapor.

35. The hydrogen production device of claim 29, wherein the device is configured as a fuel-cell for the production of electricity.

36. A hydrogen production device, comprising:
a membrane disposed within at least a portion of a housing, the membrane having a first surface and a second surface opposite the first surface;
a first chamber in fluid communication with a first fluid source, the first chamber being defined by the membrane and at least a portion of the housing; and
a second chamber in fluid communication with a second fluid source, the second chamber being defined by the membrane and at least a portion of the housing, the second chamber being in fluid communication with an outlet for the transfer of hydrogen gas; wherein
the first membrane surface comprises the surface of a first mixed ionic and electronic conductor layer of claim 8, and the second membrane surface comprises the surface of a second mixed ionic and electronic conductor layer of claim 8.
